(19) United States
(12) Patent Application Publication
(10) Pub. No.: US 2026/0080819 A1
(43) Pub. Date: Mar. 19, 2026

(54) DISPLAY PANEL AND DISPLAY APPARATUS

(71) Applicant: Tianma Advanced Display Technology Institute (Xiamen) Co., Ltd., Xiamen (CN)

(72) Inventor: Yingteng ZHAI, Xiamen (CN)

(21) Appl. No.: 19/399,663

(22) Filed: Nov. 25, 2025

(30) Foreign Application Priority Data
Jun. 20, 2025 (CN) 202510837127.7

(51) Int. Cl. G09G 3/32; G09G 3/20

(52) U.S. Cl. CPC G09G 3/32; G09G 3/2022; G09G 2300/0842; G09G 2300/0861; G09G 2310/08; G09G 2320/0233; G09G 2320/064; G09G 2330/021

(57) ABSTRACT

Display panel and display apparatus, display panel includes first and second light-emitting device with different emission colors, first pixel circuit is connected to first light-emitting device, and second pixel circuit is connected to second light-emitting device; one frame of display panel includes N sub-frames, where N is integer and N≥2; N sub-frames of pixel circuit include 1st sub-frame to Nth sub-frame ordered in ascending order of light-emitting phase duration; light-emitting device displays gray levels according to sub-frame instantaneous luminance allocation rule; first pixel circuit has light-emitting phase duration t₁₁ in 1st sub-frame corresponding to it and light-emitting phase duration t₁₂ in 2nd sub-frame corresponding to it; second pixel circuit has light-emitting phase duration t₂₁ in 1st sub-frame corresponding to it and light-emitting phase duration t₂₂ in 2nd sub-frame corresponding to it; and t₁₁/t₁₂>t₂₁/t₂₂.

### CROSS-REFERENCE TO RELATED APPLICATION

The present application claims priority to Chinese Patent Application No. 202510837127.7, filed on Jun. 20, 2025, the content of which is incorporated herein by reference in its entirety.

### TECHNICAL FIELD

The present application relates to the field of display technologies, and in particular, to a display panel and a display apparatus.

### BACKGROUND

Currently, light-emitting diodes (LEDs) are widely used in the display field. For example, Micro-LEDs and Mini-LEDs are used as display pixels, which have the characteristics of high luminous efficiency, high luminance, wide color gamut, and low power consumption. The implementation of color display requires the use of LED devices of three colors: red, green, and blue. Due to the differences in luminous efficiency between devices of different colors, how to improve the luminous efficiency of light-emitting devices and reduce power consumption has become one of the key research issues in applications.

### SUMMARY

Embodiments of the present application provide a display panel and a display apparatus to solve the technical problems of improving the luminous efficiency of light-emitting devices and reducing the power consumption of the display panel.

In a first aspect, an embodiment of the present application provides a display panel, which includes a light-emitting device and a pixel circuit, where the light-emitting device includes a first light-emitting device and a second light-emitting device with different emission colors, the pixel circuit includes a first pixel circuit and a second pixel circuit, the first pixel circuit is connected to the first light-emitting device, and the second pixel circuit is connected to the second light-emitting device; and
one frame of the display panel includes N sub-frames, where N is an integer and N≥2; an operation of the pixel circuit in a sub-frame includes a light-emitting phase, and the N sub-frames corresponding to the pixel circuit include a 1st sub-frame to an Nth sub-frame ordered in ascending order of light-emitting phase duration; the light-emitting device displays gray levels according to a sub-frame instantaneous luminance allocation rule, the sub-frame instantaneous luminance allocation rule including: a gray displayed by the light-emitting device increases as its instantaneous luminance in the sub-frame increases, the light-emitting device is allocated to emit light in a next sub-frame after reaching a maximum instantaneous luminance in a current sub-frame, and a light-emitting phase duration in the next sub-frame is not less than a light-emitting phase duration in the current sub-frame;
where the first pixel circuit has a light-emitting phase duration t₁₁ in the 1st sub-frame corresponding to the first pixel circuit and a light-emitting phase duration t₁₂ in the 2nd sub-frame corresponding to the first pixel circuit; the second pixel circuit has a light-emitting phase duration t₂₁ in the 1st sub-frame corresponding to the second pixel circuit and a light-emitting phase duration t₂₂ in the 2nd sub-frame corresponding to the second pixel circuit; and
where t₁₁/t₁₂>t₂₁/t₂₂

In a second aspect, based on the same inventive concept, an embodiment of the present application further provides a display apparatus including a display panel, and the display panel includes a light-emitting device and a pixel circuit, where the light-emitting device includes a first light-emitting device and a second light-emitting device with different emission colors, the pixel circuit includes a first pixel circuit and a second pixel circuit, the first pixel circuit is connected to the first light-emitting device, and the second pixel circuit is connected to the second light-emitting device; and
one frame of the display panel includes N sub-frames, where N is an integer and N≥2; an operation of the pixel circuit in a sub-frame includes a light-emitting phase, and the N sub-frames corresponding to the pixel circuit include a 1st sub-frame to an Nth sub-frame ordered in ascending order of light-emitting phase duration; the light-emitting device displays gray levels according to a sub-frame instantaneous luminance allocation rule, the sub-frame instantaneous luminance allocation rule including: a gray displayed by the light-emitting device increases as its instantaneous luminance in the sub-frame increases, the light-emitting device is allocated to emit light in a next sub-frame after reaching a maximum instantaneous luminance in a current sub-frame, and a light-emitting phase duration in the next sub-frame is not less than a light-emitting phase duration in the current sub-frame;
where the first pixel circuit has a light-emitting phase duration t₁₁ in the 1st sub-frame corresponding to the first pixel circuit and a light-emitting phase duration t₁₂ in the 2nd sub-frame corresponding to the first pixel circuit; the second pixel circuit has a light-emitting phase duration t₂₁ in the 1st sub-frame corresponding to the second pixel circuit and a light-emitting phase duration t₂₂ in the 2nd sub-frame corresponding to the second pixel circuit; and where t₁₁/t₁₂>t₂₁/t₂₂

### BRIEF DESCRIPTION OF DRAWINGS

To more clearly illustrate the technical solutions in the embodiments of the present application or in the prior art, a brief introduction to the accompanying drawings required to be used in the description of the embodiments or the prior art will be given below. Apparently, the accompanying drawings in the following description are some embodiments of the present application. For those of skill in the art, other drawings can also be obtained according to these drawings without exerting creative labor.

FIG. 1 is a schematic diagram of a pixel circuit provided by an embodiment of the present application;

FIG. 2 is a schematic diagram of another pixel circuit provided by an embodiment of the present application;

FIG. 3 is a schematic diagram of the allocation of instantaneous luminance and gray levels of sub-frames;

FIG. 4A is a schematic diagram of a display panel provided by an embodiment of the present application;

FIG. 4B is a schematic diagram of another display panel provided by an embodiment of the present application;

FIG. 5 is a schematic diagram of light-emitting phases of pixel circuits in sub-frames provided by an embodiment of the present application;

FIG. 6 illustrates graphs of current efficiency of light-emitting devices;

FIG. 7 is a schematic diagram of the principle of gray allocation for a first light-emitting device in an embodiment of the present application;

FIG. 8 is another schematic diagram of light-emitting phases of pixel circuits in sub-frames provided by an embodiment of the present application;

FIG. 9 is another schematic diagram of light-emitting phases of pixel circuits in sub-frames provided by an embodiment of the present application;

FIG. 10 is another schematic diagram of light-emitting phases of pixel circuits in sub-frames provided by an embodiment of the present application;

FIG. 11 is another schematic diagram of light-emitting phases of pixel circuits in sub-frames provided by an embodiment of the present application;

FIG. 12 is another schematic diagram of light-emitting phases of pixel circuits in sub-frames provided by an embodiment of the present application;

FIG. 13 is a timing diagram of light-emitting control signals provided by an embodiment of the present application;

FIG. 14 is another timing diagram of light-emitting control signals provided by an embodiment of the present application; and

FIG. 15 is a schematic diagram of a display apparatus provided by an embodiment of the present application.

### DESCRIPTION OF EXAMPLES

To make the objectives, technical solutions, and advantages of the embodiments of the present application clearer, the technical solutions in the embodiments of the present application will be clearly and completely described below in conjunction with the accompanying drawings in the embodiments of the present application. Apparently, the described embodiments are some, but not all, of the embodiments of the present application. Based on the embodiments of the present application, all other embodiments obtained by a person of ordinary skill in the art without creative efforts shall fall within the protection scope of the present application.

The terms used in the embodiments of the present application are only for the purpose of describing specific embodiments and are not intended to limit the present application. The singular forms “a”, “the”, and “said” used in the embodiments of the present application and the appended claims are also intended to include plural forms, unless the context clearly indicates otherwise.

The embodiments of the present application provide a display panel, in which a first light-emitting device and a second light-emitting device with different emission colors are connected to different pixel circuits, and thus the light-emitting durations of the two light-emitting devices can be set differently during operation, thereby compensating for the difference in luminous efficiency between the two light-emitting devices. One frame of the display panel includes N sub-frames, and the two light-emitting devices are configured to display gray levels according to a sub-frame instantaneous luminance allocation rule, so that the light-emitting devices have higher efficiency and uniformity, and the emission wavelength shift is avoided. In addition, the ratios of a light-emitting phase duration of the 1st sub-frame to a light-emitting phase duration of the 2nd sub-frame corresponding to the two pixel circuits are set differently, so that the light-emitting devices operate as much as possible under high current density, improving luminous efficiency and reducing power consumption of the display panel. The above is the main technical idea of the present application, and the present application will be described below by way of specific embodiments.

The display panel provided by the embodiments of the present application includes a light-emitting device and a pixel circuit. The light-emitting device may be a Micro-LED or a Mini-LED. The pixel circuit is electrically connected to the light-emitting device and is used to drive the light-emitting device to emit light.

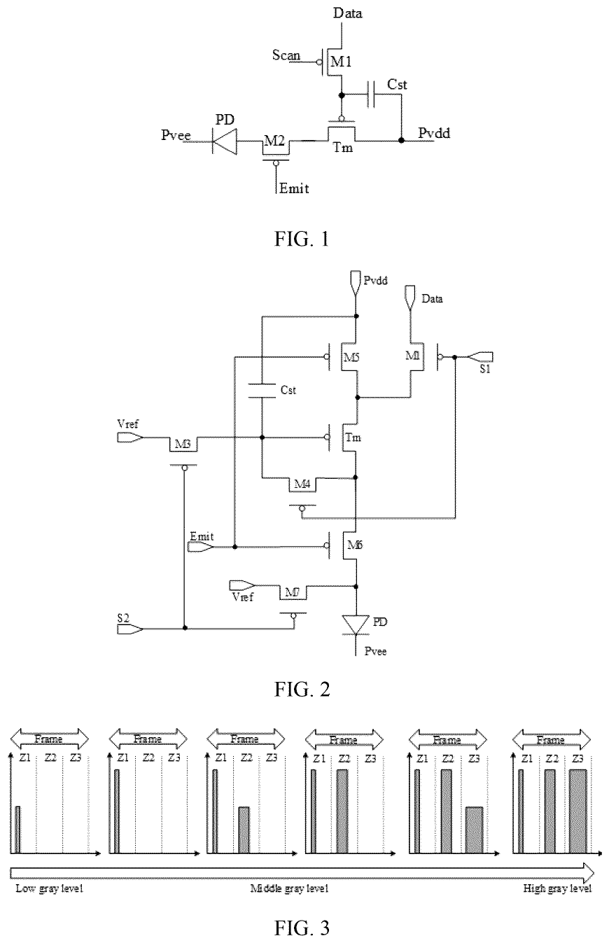

FIG. 1 is a schematic diagram of a pixel circuit provided by an embodiment of the present application. As shown in FIG. 1, the pixel circuit includes at least a driving transistor Tm, a data writing transistor M1, a light-emitting control transistor M2, and a storage capacitor Cst. The operating process of the pixel circuit includes a writing phase and a light-emitting phase. In the writing phase, the data writing transistor M1 is turned on under the control of a scan signal Scan to write a data voltage Data to a gate of the driving transistor Tm; and in the light-emitting phase, when the light-emitting control transistor M2 is turned on under the control of a light-emitting control signal Emit, the driving transistor Tm generates a driving current under the control of its gate voltage and provides the driving current to a light-emitting device PD. To drive the light-emitting device PD to emit light, a first power supply voltage Pvdd and a second power supply voltage Pvee need to be provided. Optionally, the first power supply voltage Pvdd is a positive power supply voltage, and the second power supply voltage Pvee is a negative power supply voltage. The effective pulse width of the light-emitting control signal Emit affects the light-emitting phase duration, and the light-emitting phase duration affects the actual light-emitting time of the light-emitting device PD. The light-emitting phase duration can be controlled by adjusting the effective pulse width of the light-emitting control signal Emit.

FIG. 2 is a schematic diagram of another pixel circuit provided by an embodiment of the present application. As shown in FIG. 2, the pixel circuit includes a driving transistor Tm, a data writing transistor M1, a gate reset transistor M3, a threshold compensation transistor M4, an electrode reset transistor M7, a first light-emitting control transistor M5, a second light-emitting control transistor M6, and a storage capacitor Cst. The operating process of the pixel circuit includes at least a reset phase, a writing phase, and a light-emitting phase. In the reset phase, the gate reset transistor M3 is turned on under the control of a second scan signal S2 to write a reset signal Vref to a gate of the driving transistor Tm, and the electrode reset transistor M7 is turned on under the control of the second scan signal S2 to write the reset signal Vref to an electrode of a light-emitting device PD; in the writing phase, the data writing transistor M1 and the threshold compensation transistor M4 are turned on under the control of a first scan signal S1 to write a data voltage Data to the gate of the driving transistor Tm and perform self-check and compensation on a threshold voltage of the driving transistor Tm; and in the light-emitting phase, the first light-emitting control transistor M5 and the second light-emitting control transistor M6 are turned on under the control of a light-emitting control signal Emit, and the driving transistor Tm generates a driving current under the control of its gate voltage and provides the driving current to the light-emitting device PD. The effective pulse width of the light-emitting control signal Emit affects the light-emitting phase duration, and the light-emitting phase duration affects the actual light-emitting time of the light-emitting device PD. The light-emitting phase duration can be controlled by adjusting the effective pulse width of the light-emitting control signal Emit.

The pixel circuits in FIG. 1 and FIG. 2 are only schematically represented and are not intended to limit the present application. The pixel circuit in the display panel provided by the present application may be any circuit capable of regulating the light-emitting phase duration in the operation process of the pixel circuit. Taking FIG. 2 as an example, the light-emitting control transistors (including the first light-emitting control transistor M5 and the second light-emitting control transistor M6) are connected in series with the driving transistor Tm, and the light-emitting phase duration can be regulated and controlled by controlling the turn-on duration of the light-emitting control transistors during the light-emitting phase. That is to say, the light-emitting phase duration, and thus the light-emitting duration of the light-emitting device PD, can be controlled by controlling the duration of the effective level of the light-emitting control signal Emit.

In the embodiment of the present application, a frame of the display panel includes N sub-frames, where N is an integer and N≥2. A picture displayed by the display panel is called a frame, and the frame includes sub-frames. The pixel circuit includes at least the writing phase and the light-emitting phase in one sub-frame. The display panel includes a plurality of scan lines (for providing scan signals) and a plurality of light-emitting control lines (for providing light-emitting control signals). One scan line is connected to multiple pixel circuits, and one light-emitting control line is connected to multiple pixel circuits. The scan lines and the light-emitting control lines drive the pixel circuits simultaneously: the scan lines control the writing phase, and the light-emitting control lines control the light-emitting phase. In a sub-frame, the plurality of scan lines of the display panel output enable signals sequentially from top to bottom, and the plurality of light-emitting control lines output enable signals sequentially from top to bottom. When a frame includes two or more sub-frames, in each sub-frame, the plurality of scan lines of the display panel output enable signals sequentially from top to bottom and the plurality of light-emitting control lines output enable signals sequentially from top to bottom. For example, when two sub-frames are included, for a light-emitting device PD, its luminance in the two sub-frames is superimposed to be the gray required to be displayed by it in a picture, and thus the images displayed by the display panel in the two sub-frames are superimposed to be a complete picture required to be displayed.

The operation of the pixel circuit in a sub-frame includes the light-emitting phase. The N sub-frames corresponding to the pixel circuit include a 1st sub-frame to an Nth sub-frame ordered in ascending order of light-emitting phase duration. The light-emitting device PD displays gray levels according to a sub-frame instantaneous luminance allocation rule, the sub-frame instantaneous luminance allocation rule including: the gray displayed by the light-emitting device PD increases as its instantaneous luminance in the sub-frame increases; the light-emitting device PD is allocated to emit light in the next sub-frame only after reaching the maximum instantaneous luminance in the current sub-frame; and the light-emitting phase duration in the next sub-frame is not less than the light-emitting phase duration in the current sub-frame. In a sub-frame, the instantaneous luminance of the light-emitting device PD is related to the data voltage Data written in the writing phase. The data voltage Data affects a driving current generated by a driving transistor during the light-emitting phase, and the driving current affects the instantaneous luminance. The luminance of the light-emitting device PD in a sub-frame is related to the instantaneous luminance and the light-emitting duration. When the instantaneous luminance is fixed, the longer the light-emitting duration, the greater the luminance of the light-emitting device PD in the sub-frame. When one frame includes two or more sub-frames, the superposition of the luminous luminance of the light-emitting device PD in the two or more sub-frames is the gray level displayed by the light-emitting device PD in the one frame.

Taking a frame including three sub-frames as an example, the sub-frame instantaneous luminance allocation rule is described. FIG. 3 is a schematic diagram of the allocation of instantaneous luminance and gray levels of sub-frames. In FIG. 3, the abscissa represents time, and the ordinate represents luminance. As shown in FIG. 3, a display process Frame of a picture (i.e., a frame) includes three sub-frames: a sub-frame Z1, a sub-frame Z2, and a sub-frame Z3. The width of a graphic fill in FIG. 3 represents the light-emitting duration of the light-emitting device PD in a sub-frame, and also represents the light-emitting phase duration in the sub-frame. In FIG. 3, the light-emitting phase durations of the sub-frame Z1, the sub-frame Z2, and the sub-frame Z3 gradually increase. The gray levels displayed by the light-emitting device PD gradually increase from left to right in FIG. 3. When displaying a low gray level (Low gray level), the light-emitting device PD first emits light only in the sub-frame Z1. The light-emitting phase duration of the sub-frame Z1 is fixed; it is set that the gray level displayed by the light-emitting device PD increases as its instantaneous luminance in the sub-frame Z1 increases; and the change of the instantaneous luminance is regulated and controlled by a data voltage Data written in the sub-frame Z1. When the light-emitting device PD reaches the maximum instantaneous luminance in the sub-frame Z1, the gray that is displayed using one sub-frame reaches a limit. To be able to display a larger gray level, it is necessary to allocate the light-emitting device PD to emit light in the sub-frame Z2. That is, when displaying a medium gray level (Middle gray level), the light-emitting device PD emits light in the sub-frame Z1 and the sub-frame Z2; and in the sub-frame Z1, the light-emitting device PD reaches the maximum instantaneous luminance in this sub-frame. When the light-emitting device PD reaches the maximum instantaneous luminance in the sub-frame Z1 and also reaches the maximum instantaneous luminance in the sub-frame Z2, the gray that is displayed using two sub-frames reaches a limit. The light-emitting device PD is then allocated to emit light in the sub-frame Z3 to increase the gray level that can be displayed. For example, when displaying a high gray level (High gray level), the light-emitting device PD emits light in the sub-frame Z1, the sub-frame Z2, and the sub-frame Z3; in the sub-frame Z1, the light-emitting device PD reaches the maximum instantaneous luminance in this sub-frame; and in the sub-frame Z2, the light-emitting device PD reaches the maximum instantaneous luminance in this sub-frame. When the light-emitting device PD reaches the maximum instantaneous luminance within each of the three sub-frames, the light-emitting device PD can display the maximum gray level.

Using the above-mentioned allocation rule, combined with the value range of the data voltage and the number of gray levels required to be displayed, the data voltage required to be written in each sub-frame when the light-emitting device PD displays each gray level is allocated. For example, it is finally determined that controlling the light-emitting device PD to emit light in the sub-frame Z1 can display 0˜70 grays, controlling the light-emitting device PD to emit light in the sub-frame Z1 and the sub-frame Z2 can display 71˜200 grays, and controlling the light-emitting device PD to emit light in all three sub-frames can display 201˜255 grays. When displaying a low gray level, light emission is preferentially performed in the sub-frame with a shorter light-emitting phase duration. As the gray level to be displayed increases, light emission in the sub-frame with a longer light-emitting phase duration is allowed only when the maximum instantaneous luminance is reached in the sub-frame with a shorter light-emitting phase duration. When the gray level is lower, the light-emitting device PD is turned on only during the sub-frame with the shortest light-emitting phase duration. The shorter the light-emitting duration of the light-emitting device PD, the greater the current density, and thus the better the performance of the light-emitting device PD. Using the sub-frame instantaneous luminance allocation rule to allocate the light-emitting device to display different gray levels can improve the luminous efficiency of the light-emitting device, avoid emission wavelength shift, and improve uniformity.

It should be noted that the instantaneous luminance of the light-emitting device generally refers to the luminance of the light-emitting device detected within a microsecond-level time period. The instantaneous luminance of the light-emitting device corresponds to the data voltage. The range of the data voltage that can be provided by a display driver chip in a finished electronic device is determined, i.e., the data voltage written into the pixel circuit has a maximum value and a minimum value. And the maximum instantaneous luminance of the light-emitting device in a sub-frame generally refers to writing the extreme value of the data voltage to cause the light-emitting device to reach the maximum luminance in that sub-frame. It is necessary to allocate the instantaneous luminance of the light-emitting device PD in each sub-frame according to the gray level, and the instantaneous luminance is related to the data voltage. However, since the gray levels are discontinuous, there may be differences in the data voltages corresponding to the maximum instantaneous luminance achieved by the light-emitting device PD in different sub-frames during allocation, and thus there will be certain differences in the maximum instantaneous luminance. It can be understood that to rationally utilize the range of the data voltage that can be provided, the extreme value of the data voltage is written in each sub-frame as much as possible to maximize the luminance of the light-emitting device PD. Although there are differences in the maximum instantaneous luminance corresponding to the light-emitting device PD in different sub-frames, the luminance should be relatively close, and the difference between the data voltages corresponding to the maximum instantaneous luminance in each sub-frame will not be significant. For example, the difference between the data voltages corresponding to the maximum instantaneous luminance in different sub-frames is not greater than 0.2ΔV, where ΔV is the voltage difference between the maximum value and the minimum value of the data voltage provided by the display panel.

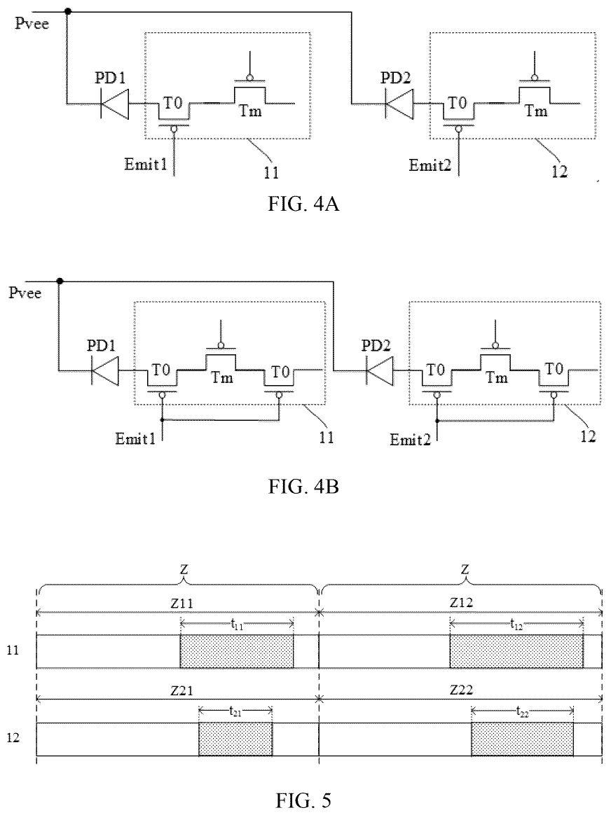

In an embodiment of the present application, the light-emitting device includes the first light-emitting device and the second light-emitting device with different emission colors, and the pixel circuit includes a first pixel circuit and a second pixel circuit. The first pixel circuit is connected to the first light-emitting device, and the second pixel circuit is connected to the second light-emitting device. FIG. 4A is a schematic diagram of a display panel provided by an embodiment of the present application. As shown in FIG. 4A, the first pixel circuit 11 is connected to the first light-emitting device PD1, and the second pixel circuit 12 is connected to the second light-emitting device PD2. The first pixel circuit 11 and the second pixel circuit 12 each include a driving transistor Tm and a light-emitting control transistor T0, where the driving transistor Tm and the light-emitting control transistor T0 are connected in series. A control terminal of the light-emitting control transistor T0 in the first pixel circuit 11 receives a first light-emitting control signal Emit1, and a control terminal of the light-emitting control transistor T0 in the second pixel circuit 12 receives a second light-emitting control signal Emit2. The light-emitting phase durations of the first pixel circuit 11 and the second pixel circuit 12 are controlled by the first light-emitting control signal Emit1 and the second light-emitting control signal Emit2, respectively. It can be understood that when the pixel circuits in FIG. 4A each have the structure schematically shown in FIG. 1, the light-emitting control transistor T0 is the light-emitting control transistor M2.

In further implementations, FIG. 4B is a schematic diagram of another display panel provided by an embodiment of the present application. As shown in FIG. 4B, the first pixel circuit 11 is connected to the first light-emitting device PD1, and the second pixel circuit 12 is connected to the second light-emitting device PD2. The first pixel circuit 11 and the second pixel circuit 12 each include a driving transistor Tm and two light-emitting control transistors T0, where the driving transistor Tm is connected in series between the two light-emitting control transistors T0. Control terminals of the light-emitting control transistors T0 in the first pixel circuit 11 are connected to a first light-emitting control line Emit1, and control terminals of the light-emitting control transistors T0 in the second pixel circuit 12 are connected to a second light-emitting control line Emit2. It can be understood that when the pixel circuits in FIG. 4B each have the structure schematically shown in FIG. 2, the two light-emitting control transistors T0 are the first light-emitting control transistor M5 and the second light-emitting control transistor M6, respectively, and the driving transistor Tm is connected in series between the first light-emitting control transistor M5 and the second light-emitting control transistor M6.

One frame of the display panel includes N sub-frames, where N is an integer and N≥2. The N sub-frames corresponding to the first pixel circuit 11 include a 1st sub-frame to an Nth sub-frame ordered in ascending order of light-emitting phase duration, and the N sub-frames corresponding to the second pixel circuit 12 include a 1st sub-frame to an Nth sub-frame ordered in ascending order of light-emitting phase duration. The first light-emitting device PD1 and the second light-emitting device PD2 display gray levels according to the sub-frame instantaneous luminance allocation rule, respectively.

It should be noted here that a frame includes N sub-frames, and the N sub-frames of a frame can be ordered in two ways: one way is to sort the N sub-frames by the light-emitting phase duration in the sub-frames, and the other is to sort the N sub-frames by the time sequence of display. When the N sub-frames included in a frame are ordered in ascending order of light-emitting phase duration, the N sub-frames corresponding to the first pixel circuit 11 include the 1st sub-frame to the Nth sub-frame, and the N sub-frames corresponding to the second pixel circuit 12 include the 1st sub-frame to the Nth sub-frame. And the 1st sub-frame corresponding to the first pixel circuit 11 and the 1st sub-frame corresponding to the second pixel circuit 12 may be the same sub-frame displayed in chronological order, or different sub-frames displayed in chronological order. In the following embodiments, references to the 1st sub-frame, 2nd sub-frame, ith sub-frame, etc., all refer to the sub-frames ordered in ascending order of light-emitting phase duration unless otherwise specified.

FIG. 5 is a schematic diagram of light-emitting phases of pixel circuits in sub-frames provided by an embodiment of the present application. FIG. 5 schematically illustrates two sub-frames Z in a frame display, and identifies a 1st sub-frame Z11 and a 2nd sub-frame Z12 corresponding to the first pixel circuit 11, and a 1st sub-frame Z21 and a 2nd sub-frame Z22 corresponding to the second pixel circuit 12. FIG. 5 does not define the chronological order of display of the 1st sub-frame and the 2nd sub-frame. The position of the light-emitting phase in a sub-frame Z is filled with a pattern for illustration. The first pixel circuit 11 has a light-emitting phase duration t₁₁ in the 1st sub-frame Z11 corresponding to it and a light-emitting phase duration t₁₂ in the 2nd sub-frame Z12 corresponding to it; and the second pixel circuit 12 has a light-emitting phase duration t₂₁ in the 1st sub-frame Z21 corresponding to it and a light-emitting phase duration t₂₂ in the 2nd sub-frame Z22 corresponding to it; where t₁₁/t₁₂>t₂₁/t₂₂.

In related art, when a frame of a display panel includes N sub-frames and a light-emitting device PD displays gray levels according to the sub-frame instantaneous luminance allocation rule, pixel circuits electrically connected to light-emitting devices PD with different emission colors are controlled by the same light-emitting control signal Emit. That is, in the basic multi-sub-frame driving scheme, the pixel circuits connected to the light-emitting devices with different colors have the same light-emitting phase duration in the same sub-frame. Namely, the 1st sub-frame corresponding to the pixel circuit connected to the first light-emitting device PD1 and the 1st sub-frame corresponding to the pixel circuit connected to the second light-emitting device PD2 are the same sub-frame displayed in chronological order, and the light-emitting phase durations of the 1st sub-frames corresponding to the two pixel circuits are the same. The 2nd sub-frame corresponding to the pixel circuit connected to the first light-emitting device PD1 and the 2nd sub-frame corresponding to the pixel circuit connected to the second light-emitting device PD2 are the same sub-frame displayed in chronological order, and the light-emitting phase durations of the 2nd sub-frames corresponding to the two pixel circuits are the same. In related art, the relationships are: t₁₁=t₂₁, t₁₂=t₂₂, and t₁₁/t₁₂−t₂₁/t₂₂. However, in the embodiment of the present application, it is set that t₁₁/t₁₂>t₂₁/t₂₂, which is equivalent to increasing t₁₁, that is, the light-emitting phase duration t₁₁ of the 1st sub-frame Z11 corresponding to the first pixel circuit 11 is set to be relatively longer.

In the display panel provided by the embodiment of the present application, it is set that the first light-emitting device PD1 and the second light-emitting device PD2 with different emission colors are connected to the first pixel circuit 11 and the second pixel circuit 12, respectively, a frame of the display panel includes N sub-frames, and the light-emitting phase durations of the first pixel circuit 11 and the second pixel circuit 12 in a sub-frames can be controlled independently of each other. The first pixel circuit 11 and the second pixel circuit 12 correspond to the 1st sub-frame to the Nth sub-frame ordered in ascending order of light-emitting phase duration, respectively, and the first light-emitting device PD1 and the second light-emitting device PD2 display gray levels according to the sub-frame instantaneous luminance allocation rule, respectively. Moreover, it is set that t₁₁/t₁₂>t₂₁/t₂₂, so that the light-emitting phase duration t₁₁ of the 1st sub-frame Z11 corresponding to the first pixel circuit 11 is set to be relatively longer. When the gray levels are allocated to the first light-emitting device PD1 according to the sub-frame instantaneous luminance allocation rule, more grays can be allocated in the 1st sub-frame Z11 where the first pixel circuit 11 operates, so that the starting gray of the 2nd sub-frame Z12 is higher. When the first light-emitting device PD1 emits light in both the 1st sub-frame Z11 and the 2nd sub-frame Z12, the first light-emitting device PD1 has already reached the maximum instantaneous luminance in the 1st sub-frame Z11, which can compensate to a certain extent for the low efficiency and non-uniformity caused by the low current in the initial stage in the 2nd sub-frame Z12, and the current density in the 2nd sub-frame Z12 will also increase rapidly, ensuring the luminous efficiency of the first light-emitting device PD1. When the display panel operates in a relatively high luminance mode, it can be ensured that the first light-emitting device PD1 has high luminous efficiency, reducing the power consumption of the display panel and improving display uniformity.

In the embodiment of the present application, the 1st sub-frame Z11 corresponding to the first pixel circuit 11 is the sub-frame with the shortest light-emitting phase duration among the N sub-frames corresponding to the first pixel circuit 11, and the 1st sub-frame Z21 corresponding to the second pixel circuit 12 is the sub-frame with the shortest light-emitting phase duration among the N sub-frames corresponding to the second pixel circuit 12. The light-emitting phase duration of the 1st sub-frame Z11 corresponding to the first pixel circuit 11 is t₁₁, and the light-emitting phase duration of the 1st sub-frame Z21 corresponding to the second pixel circuit 12 is t₂₁, where t₁₁>t₂₁. Compared with the scheme in which the light-emitting phase durations in the sub-frames with the shortest light-emitting phase durations are the same for the two pixel circuits for driving the first light-emitting device PD1 and the second light-emitting device PD2, in the embodiment of the present application, the light-emitting phase duration in the sub-frame with the shortest light-emitting phase duration is increased for the pixel circuit connected to the first light-emitting device PD1. As a result, more grays can be allocated to the first light-emitting device PD1 in the 1st sub-frame Z11 where the first pixel circuit 11 operates, so that the starting gray of the 2nd sub-frame Z12 is higher. When the display panel operates in a relatively high luminance mode, it can be ensured that the first light-emitting device PD1 has high luminous efficiency and high luminance uniformity.

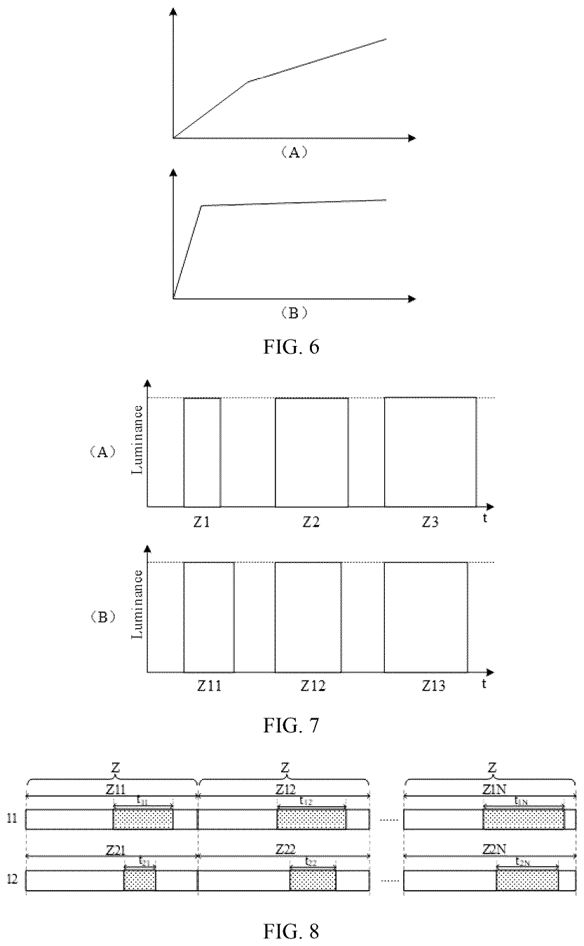

FIG. 6 illustrates graphs of current efficiency of light-emitting devices. A sub-graph (A) in FIG. 6 is a current efficiency curve of the first light-emitting device PD1, and a sub-graph (B) in FIG. 6 is a current efficiency curve of the second light-emitting device PD2. The abscissas represent current, and the ordinates represent luminous efficiency. The luminous efficiency of the first light-emitting device PD1 changes slowly with current, that is, the first light-emitting device PD1 is enabled to achieve high luminous efficiency only when there is a larger current. In contrast, the luminous efficiency of the second light-emitting device PD2 increases rapidly with current until saturation, and thus the second light-emitting device PD2 can also achieve high luminous efficiency at a relatively smaller current.

In the embodiment of the present application, by increasing t₁₁, it is achieved that t₁₁/t₁₂>t₂₁/t₂₂. Increasing the light-emitting duration of the first pixel circuit 11 connected to the first light-emitting device PD1 in the sub-frame with the shortest light-emitting duration enables the light emission of the first light-emitting device PD1 in the 1st sub-frame Z11 to cover more grays, increasing the starting gray of the first light-emitting device PD1 in the 2nd sub-frame Z12. When the first light-emitting device PD1 emits light in both the 1st sub-frame Z11 and the 2nd sub-frame Z12, the first light-emitting device PD1 has already reached the maximum instantaneous luminance in the 1st sub-frame Z11, which can compensate to a certain extent for the low efficiency and non-uniformity caused by the low current in the initial stage in the 2nd sub-frame Z12. Moreover, the current density in the 2nd sub-frame Z12 will increase rapidly, thereby being capable of improving the luminous efficiency of the first light-emitting device PD1. For the second light-emitting device PD2, since its luminous efficiency increases rapidly with the current increases until saturation, even if its light-emitting phase duration in the 1st sub-frame Z21 is set to be shorter, the second light-emitting device PD2 can still emit light with high efficiency.

In some implementations, an emission wavelength of the first light-emitting device PD1 is longer than an emission wavelength of the second light-emitting device PD2. For example, the first light-emitting device PD1 is a red light-emitting device, and the second light-emitting device PD2 is a green light-emitting device or a blue light-emitting device. In the display panel, the red light-emitting device is electrically connected to the first pixel circuit 11, and the green light-emitting device or the blue light-emitting device is electrically connected to the second pixel circuit 12.

In some implementations, the display panel includes a first light-emitting device PD1, a second light-emitting device PD2, and a third light-emitting device. A emission wavelength of the first light-emitting device PD1 is longer than an emission wavelength of the second light-emitting device PD2 and longer than an emission wavelength of the third light-emitting device. The first light-emitting device PD1 is a red light-emitting device, and the red light-emitting device is electrically connected to the first pixel circuit 11. One of the second light-emitting device PD2 and the third light-emitting device is a green light-emitting device, and the other is a blue light-emitting device; and the green light-emitting device and the blue light-emitting device are electrically connected to the second pixel circuit 12, respectively.

In the embodiment of the present application, the first light-emitting device PD1 emits light and reaches the maximum instantaneous luminance in the 1st sub-frame Z11 corresponding to the first pixel circuit 11, and the gray displayed by the first light-emitting device PD1 is Gm1; the second light-emitting device PD2 emits light and reaches the maximum instantaneous luminance in the 1st sub-frame Z21 corresponding to the second pixel circuit 12, and the gray displayed by the second light-emitting device PD2 is Gm2; where Gm1>Gm2. That is, when the first light-emitting device PD1 and the second light-emitting device PD2 display gray levels according to the sub-frame instantaneous luminance allocation rule, respectively, compared with the second light-emitting device PD2, the first light-emitting device PD1 is allocated a greater number of grays when emitting light in the sub-frame with the shortest light-emitting phase duration, and the gray adjustment range of the first light-emitting device PD1 in the 1st sub-frame Z11 corresponding to the first light-emitting device PD1 is wider, and thus the starting gray of the first light-emitting device PD1 in the 2nd sub-frame Z12 corresponding to the first light-emitting device PD1 is larger.

FIG. 7 is a schematic diagram of the principle of gray allocation for a first light-emitting device in an embodiment of the present application. Taking N=3 as an example, a subgraph (A) in FIG. 7 shows an scheme before improvement, where the 3 sub-frames corresponding to a pixel circuit are ordered in ascending order of light-emitting phase duration as a 1st sub-frame Z1, a 2nd sub-frame Z2, and a 3rd sub-frame Z3. A subgraph (B) in FIG. 7 shows the improved scheme of the embodiment of the present application, where the 3 sub-frames corresponding to the first pixel circuit are ordered in ascending order of light-emitting phase duration as a 1st sub-frame Z11, a 2nd sub-frame Z12, and a 3rd sub-frame Z13. Compared with the subgraph (A) in FIG. 7, the light-emitting phase duration of the 1st sub-frame Z11 is increased in the subgraph (B) in FIG. 7 (i.e., the light-emitting phase duration of the 1st sub-frame Z11 is longer than the light-emitting phase duration of the 1st sub-frame Z1), while the total light-emitting phase duration of the three sub-frames remains unchanged. The abscissas represent time t, and the ordinates represent luminance (Luminance). The instantaneous luminance of the light-emitting device is related to the data voltage Data. Since the adjustable range of the data voltage Data is fixed in the display panel, the variation range of the instantaneous luminance of the light-emitting device PD in each sub-frame is the same.

According to the sub-frame instantaneous luminance allocation rule, in the scheme of the subgraph (A) in FIG. 7, for example, the light-emitting device PD can display 0˜50 grays when emitting light in the 1st sub-frame Z1; when the maximum instantaneous luminance is reached in the 1st sub-frame Z1, the light-emitting device PD can display 51˜140 grays when emitting light in the 2nd sub-frame Z2; and when the maximum instantaneous luminance is reached in both the 1st sub-frame Z1 and the 2nd sub-frame Z2, the light-emitting device PD can display 141˜255 grays when emitting light in the 3rd sub-frame Z3.

In the improved scheme of the subgraph (B) in FIG. 7, the light-emitting phase duration of the 1st sub-frame Z11 is increased, while the variation range of the instantaneous luminance of the first light-emitting device PD1 in each sub-frame remains unchanged. The gray displayed by the light emission of the first light-emitting device PD1 is related to the instantaneous luminance and the light-emitting phase duration: with a fixed light-emitting phase duration, the greater the instantaneous luminance, the greater the gray; and with a fixed instantaneous luminance, the longer the light-emitting phase duration, the greater the gray. The light-emitting phase duration of the first light-emitting device PD1 in the 1st sub-frame Z11 is fixed, and thus the gray displayed by the light emission of the first light-emitting device PD1 in the 1st sub-frame Z11 increases as the instantaneous luminance increases. Compared with the subgraph (A) in FIG. 7, the light-emitting phase duration of the first light-emitting device PD1 in the 1st sub-frame Z11 is longer in the subgraph (B) in FIG. 7, and thus the range of gray that the first light-emitting device PD1 can display in the 1st sub-frame Z11 is wider in the subgraph (B) in FIG. 7. The value of the gray displayed when the first light-emitting device PD1 reaches the maximum instantaneous luminance in the 1st sub-frame Z11 is greater than the value of the gray displayed when the light-emitting device PD reaches the maximum instantaneous luminance in the 1st sub-frame Z1. This makes it possible to increase the starting gray of the light emission of the first light-emitting device PD1 in the 2nd sub-frame Z12. For example, the grays that the first light-emitting device PD1 can display when emitting light in the 1st sub-frame Z11 are 0˜60; when the maximum instantaneous luminance is reached in the 1st sub-frame Z11, the grays that the first light-emitting device PD1 can display when emitting light in the 2nd sub-frame Z12 are 61˜150; and when the maximum instantaneous luminance is reached in both the 1st sub-frame Z11 and the 2nd sub-frame Z12, the grays that the first light-emitting device PD1 can display when emitting light in the 3rd sub-frame Z13 are 151˜255.

From the above principle description, it can be understood that increasing the light-emitting phase duration of the 1st sub-frame Z11 corresponding to the first pixel circuit 11 (such that t₁₁/t₁₂>t₂₁/t₂₂) can expand the adjustable gray range of the first light-emitting device PD1 when emitting light in the 1st sub-frame Z11, such that the gray displayed by the first light-emitting device PD1 when reaching the maximum instantaneous luminance in the 1st sub-frame Z11 corresponding to the first pixel circuit 11 is larger than the gray displayed by the second light-emitting device PD2 when reaching the maximum instantaneous luminance in the 1st sub-frame Z21 corresponding to the second pixel circuit 12.

In some implementations, N≥3. The first light-emitting device PD1 emits light in n consecutive sub-frames ordered in ascending order of light-emitting phase duration and corresponding to the first pixel circuit 11, and reaches the maximum instantaneous luminance in the n sub-frames, with the gray displayed by the first light-emitting device PD1 being Gm3, where 2≤n<N. The “n consecutive sub-frames” here refer to n sub-frames within one frame. The second light-emitting device PD2 emits light in n consecutive sub-frames ordered in ascending order of light-emitting phase duration and corresponding to the second pixel circuit 12, and reaches the maximum instantaneous luminance in the n sub-frames, with the gray displayed by the second light-emitting device PD2 being Gm4; and where Gm3>Gm4.

For example, when N=3 and n=2: the first light-emitting device PD1 emits light in 2 consecutive sub-frames ordered in ascending order of light-emitting phase duration and corresponding to the first pixel circuit 11, and reaches the maximum instantaneous luminance in the 2 sub-frames, with the gray displayed by the first light-emitting device PD1 being Gm3; the second light-emitting device PD2 emits light in 2 consecutive sub-frames ordered in ascending order of light-emitting phase duration and corresponding to the second pixel circuit 12, and reaches the maximum instantaneous luminance in the 2 sub-frames, with the gray displayed by the second light-emitting device PD2 being Gm4; and where Gm3>Gm4. That is, the adjustable range of gray achieved by the light emission of the first light-emitting device PD1 in the 1st and 2nd sub-frames corresponding to the first pixel circuit 11 is wider than the adjustable range of gray achieved by the light emission of the second light-emitting device PD2 in the 1st and 2nd sub-frames corresponding to the second pixel circuit 12. In other words, the maximum gray that the first light-emitting device PD1 can display when emitting light in the 1st and 2nd sub-frames corresponding to the first pixel circuit 11 is larger than the maximum gray that the second light-emitting device PD2 can display when emitting light in the 1st and 2nd sub-frames corresponding to the second pixel circuit 12.

In some implementations of the present application, FIG. 8 is another schematic diagram of light-emitting phases of pixel circuits in sub-frames provided by an embodiment of the present application. FIG. 8 schematically illustrates that a 1st sub-frame Z11, a 2nd sub-frame Z12, . . . , and an Nth sub-frame ZIN ordered from left to right are the N sub-frames ordered in ascending order of light-emitting phase duration and corresponding to a first pixel circuit 11; and a 1st sub-frame Z21, a 2nd sub-frame Z22, . . . , and an Nth sub-frame Z2N ordered from left to right are the N sub-frames ordered in ascending order of light-emitting phase duration and corresponding to a second pixel circuit 12. The first pixel circuit 11 has a light-emitting phase duration t₁₁ in the 1st sub-frame Z11 corresponding to it, a light-emitting phase duration t₁₂ in the 2nd sub-frame Z12 corresponding to it, and a light-emitting phase duration t_{1N} in the Nth sub-frame ZIN corresponding to it. The second pixel circuit 12 has a light-emitting phase duration t₂₁ in the 1st sub-frame Z21 corresponding to it, a light-emitting phase duration t₂₂ in the 2nd sub-frame Z22 corresponding to it, and a light-emitting phase duration tax in the Nth sub-frame Z2N corresponding to it.

The first pixel circuit 11 has a light-emitting phase duration t₁ᵢ in an ith sub-frame Z1i corresponding to it, and the second pixel circuit 12 has a light-emitting phase duration t₂ᵢ in an ith sub-frame Z2i corresponding to it, where i is an integer and 1≤i≤N; and t1i>t2i. That is, the N sub-frames in one frame corresponding to the first pixel circuit 11 and the N sub-frames in one frame corresponding to the second pixel circuit 12 are respectively ordered in ascending order of light-emitting phase duration, and for the corresponding two sub-frames at the same sequence position, the light-emitting phase duration of the first pixel circuit 11 is longer than the light-emitting phase duration of the second pixel circuit 12. For example, the first light-emitting device PD1 is a red light-emitting device and the second light-emitting device PD2 is a green or blue light-emitting device, using the setting in the embodiment of the present application can make the light-emitting duration of the first light-emitting device PD1 longer than the light-emitting duration of the second light-emitting device PD2, thereby being capable of compensating for the difference in luminous efficiency between the light-emitting devices of different colors and improving the display effect of the display panel.

In some implementations, i is an integer, and 1<i≤N; the light-emitting phase duration of the first pixel circuit 11 in the ith sub-frame Z1i corresponding to it is t₁ᵢ, and the light-emitting phase duration of the second pixel circuit 12 in the ith sub-frame Z2i corresponding to it is t₂ᵢ, where t₁ᵢ>t₂ᵢ.

In the embodiment of the present application, the total light-emitting phase duration of the first pixel circuit 11 in the N sub-frames included in one frame is t₁, and the total light-emitting phase duration of the second pixel circuit 12 in the N sub-frames included in one frame is t₂, where t₁>t₂.

$$t 1 = {\sum }_{i}^{N} {t}_{1 i} = {t}_{11} + {t}_{12} + … + {t}_{1 N} ; and t 2 = {\sum }_{i}^{N} {t}_{2 i = {t}_{21} + {t}_{22} + … + {t}_{2 N} .}$$

Herein, t₁₁ is the light-emitting phase duration in the 1st sub-frame ordered by the light-emitting phase duration and corresponding to the first pixel circuit 11; t₁₂ is the light-emitting phase duration in the 2nd sub-frame ordered by the light-emitting phase duration and corresponding to the first pixel circuit 11; and t_{1N} is the light-emitting phase duration in the Nth sub-frame ordered by the light-emitting phase duration and corresponding to the first pixel circuit 11. t₂₁ is the light-emitting phase duration in the 1st sub-frame ordered by the light-emitting phase duration and corresponding to the second pixel circuit 12; t₂₂ is the light-emitting phase duration in the 2nd sub-frame ordered by the light-emitting phase duration and corresponding to the second pixel circuit 12; t_{2N} is the light-emitting phase duration in the Nth sub-frame ordered by the light-emitting phase duration and corresponding to the second pixel circuit 12. The above formulas are schematically illustrated with N≥3. When N=2, it can be understood that t₁=t₁₁+t₁₂ and t₂=t₂₁+t₂₂.

For example, the first light-emitting device PD1 is a red light-emitting device, and the second light-emitting device PD2 is a green or blue light-emitting device. The light-emitting duration of the first light-emitting device PD1 is longer than the light-emitting duration of the second light-emitting device PD2 when displaying the same gray. As a result, it is possible to compensate for the difference in luminous efficiency between the light-emitting devices of different colors and improve the display effect of the display panel.

In some implementations, the light-emitting phase duration of the first pixel circuit 11 in the ith sub-frame Z1i corresponding to it is t₁ᵢ, the light-emitting phase duration of the second pixel circuit 12 in the ith sub-frame Z2i corresponding to it is t₂ᵢ, a light-emitting phase duration of the first pixel circuit 11 in an (i−1)th sub-frame Z1(i−1) corresponding to it is t₁₍ᵢ₋₁₎, and the light-emitting phase duration of the second pixel circuit 12 in an (i−1)th sub-frame Z2(i−1) corresponding to it is t₂₍ᵢ₋₁₎; where i is an integer, and 1≤i−1≤N−1; and t₁ᵢ−t₁₍ᵢ₋₁₎≥t₂ᵢ−t₂₍ᵢ₋₁₎. For example, when N=3 and i=2, t₁₂−t₁₁≥t₂₂−t₂₁; and when N=3 and i=3, t₁₃−t₁₂≥t₂₃−t₂₂. It can be understood that t₁₃ represents a light-emitting phase duration of the first pixel circuit 11 in a 3rd sub-frame Z13 corresponding to it, and t₂₃ represents a light-emitting phase duration of the second pixel circuit 12 in the 3rd sub-frame Z23 corresponding to it. In the embodiment of the present application, it is set that the N sub-frames in one frame corresponding to the first pixel circuit 11 and the N sub-frames in one frame corresponding to the second pixel circuit 12 are respectively ordered in ascending order of light-emitting phase duration, and the difference between the light-emitting phase durations of two sub-frames at adjacent sequence positions is calculated (the longer light-emitting phase duration minus the shorter light-emitting phase duration). For the differences at the same sorting position for the first pixel circuit 11 and the second pixel circuit 12, the difference corresponding to the first pixel circuit 11 is greater than the difference corresponding to the second pixel circuit 12, i.e., t₁ᵢ−t₁₍ᵢ₋₁₎>t₂ᵢ−t₂₍ᵢ₋₁₎, or the difference corresponding to the first pixel circuit 11 is equal to the difference corresponding to the second pixel circuit 12, i.e., t₁ᵢ−tᵢ₍ᵢ₋₁₎=t₂ᵢ−t₂₍ᵢ₋₁₎.

When t₁ᵢ₋ₜ₁₍ᵢ₋₁₎>t₂ᵢ−t₂₍ᵢ₋₁₎, combined with t₁/t₁₂>t₂₁/t₂₂ and t₁ᵢ>t₂ᵢ, this is equivalent to the fact that the gradually increasing amplitude of the light-emitting phase durations ordered in ascending order of light-emitting phase duration of the N sub-frames corresponding to the first pixel circuit 11 is greater than the gradually increasing amplitude of the light-emitting phase durations of the N sub-frames corresponding to the second pixel circuit 12, and it enables the sum of the light-emitting phase durations of the N sub-frames corresponding to the first pixel circuit 11 is longer than the sum of the light-emitting phase durations of the N sub-frames corresponding to the second pixel circuit 12. As a result, this can compensate for the difference in luminous efficiency between the light-emitting devices of different colors and improving the display effect of the display panel.

When t₁ᵢ−t₁₍ᵢ₋₁₎−t₂ᵢ−t_{2(i-1),} at least in the 1st sub-frame with the shortest light-emitting phase duration, the following is satisfied: the light-emitting phase duration of the 1st sub-frame corresponding to the first pixel circuit 11 is longer than the light-emitting phase duration of the 1st sub-frame corresponding to the second pixel circuit 12, i.e., t₁₁>t₂₁, whereby it is possible to satisfy t₁₁/t₁₂>t₂₁/t₂₂. Furthermore, combined with t₁ᵢ−t₁₍ᵢ₋₁₎=t₂ᵢ−t₂₍ᵢ₋₁₎, it can be realized that the sum of the light-emitting phase durations of the N sub-frames corresponding to the first pixel circuit 11 is longer than the sum of the light-emitting phase durations of the N sub-frames corresponding to the second pixel circuit 12, thereby being capable of compensating for the difference in luminous efficiency between the light-emitting devices of different colors and improving the display effect of the display panel.

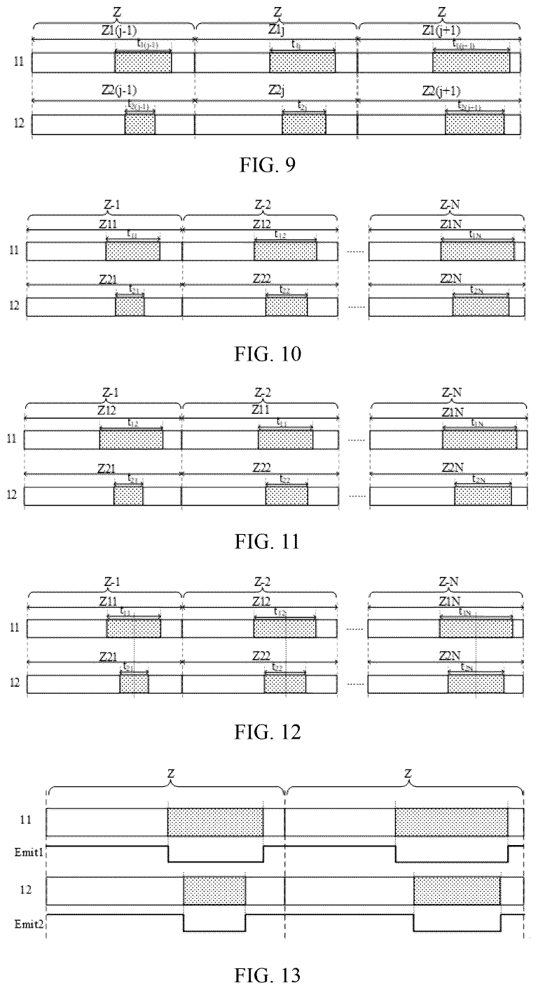

In some implementations, FIG. 9 is another schematic diagram of light-emitting phases of pixel circuits in sub-frames provided by an embodiment of the present application. FIG. 9 schematically illustrates that a (j−1)th sub-frame Z1(j−1), a jth sub-frame Z1j, and a (j+1)th sub-frame Z1(j+1) ordered from left to right are 3 sub-frames corresponding to the first pixel circuit 11 and ordered in ascending order of light-emitting phase duration. FIG. 9 also schematically illustrates that a (j−1)th sub-frame Z2(j−1), a jth sub-frame Z2j, and a (j+1)th sub-frame Z2(j+1) ordered from left to right are 3 sub-frames corresponding to the second pixel circuit 12 and ordered in ascending order of light-emitting phase duration. j is an integer, and 2<j+1≤N. The first pixel circuit 11 has a light-emitting phase duration t₁ⱼ in the jth sub-frame Z1j corresponding to it and a light-emitting phase duration t₁₍ᵢ₊₁₎ in the (j+1)th sub-frame Z1(j+1) corresponding to it; the second pixel circuit 12 has a light-emitting phase duration t₂ⱼ in the jth sub-frame Z2j corresponding it and a light-emitting phase duration t₂₍ⱼ₊₁₎ in the (j+1)th sub-frame Z2(j+1) corresponding to it; and t₁ⱼ/t₁₍ⱼ₊₁₎>t₂ⱼ/t₂₍ⱼ₊₁₎. In the embodiment of the present application, first it is set that t₁₁/t₁₂>t₂₁/t₂₂, so that the light-emitting phase duration t₁₁ of the 1st sub-frame Z11 corresponding to the first pixel circuit 11 is set to be relatively longer. When gray levels are allocated to the first light-emitting device PD1 according to the sub-frame instantaneous luminance allocation rule, more grays can be allocated in the 1st sub-frame Z11 where the first pixel circuit 11 operates, so that the first light-emitting device PD1 has a higher starting gray when emitting light in the 2nd sub-frame Z12. Further, it is set that t₁ⱼ/t₁₍ⱼ₊₁₎>t₂ⱼ/t₂₍ᵢ₋₁₎, and since t₁ⱼ/t₁₍ⱼ₊₁₎ is larger, when gray levels are allocated using the sub-frame instantaneous luminance allocation rule, the gray displayed by the first light-emitting device PD1 when it emits light and reaches the maximum instantaneous luminance in all sub-frames from the 1st to the jth will be greater than the gray displayed by the second light-emitting device PD2 when it emits light and reaches the maximum instantaneous luminance in all sub-frames from the 1st to the jth. Combined with the difference in the efficiency-current curves between the first light-emitting device PD1 and the second light-emitting device PD2, the settings of the embodiment of the present application can enable the first light-emitting device PD1 to display a greater number of grays with high efficiency, thereby being capable of reducing the power consumption of the display panel.

In some implementations, N≥3, j is an integer, and 2<j+1≤N. As illustrated in FIG. 9, the first pixel circuit 11 has a light-emitting phase duration t₁₍ⱼ₋₁₎ in the (j−1)th sub-frame Z1(j−1) corresponding to it, the light-emitting phase duration t₁ⱼ in the jth sub-frame Z1j corresponding to it, and the light-emitting phase duration t₁₍ⱼ₊₁₎ in the (j+1)th sub-frame Z1(j+1) corresponding to it; where t₁₍ⱼ₋₁₎/t₁ⱼ≤t₁ⱼ/t₁₍ⱼ₊₁₎. In these implementations, the N sub-frames of the first pixel circuit 11 in one frame are ordered in ascending order of light-emitting phase duration, and the ratio of the light-emitting phase durations of two adjacent sub-frames in the sorting gradually increases. That is, the light-emitting phase durations corresponding to the N sub-frames ordered in ascending order of light-emitting phase duration gradually increase, and the increasing amplitude gradually becomes larger. Thus, it is possible to match the sub-frame instantaneous luminance allocation rule and the light-emitting characteristics of the LED, enabling the first light-emitting device PD1 to emit light more often with high efficiency, and also to be able to avoid the emission wavelength shift and improve the display effect.

In some implementations, N≥3, j is an integer, and 2<j+1≤N. As illustrated in FIG. 9, the second pixel circuit 12 has a light-emitting phase duration t₂₍ⱼ₋₁₎ in the (j−1)th sub-frame Z2(j−1) corresponding to it, the light-emitting phase duration t₂ⱼ in the jth sub-frame Z2j corresponding to it, and the light-emitting phase duration t₂₍ⱼ₋₁₎ in the (j+1)th sub-frame Z2(j+1) corresponding to it; where t₂₍ⱼ₋₁₎/t₂ⱼ≤t₂ⱼ/t₂₍ⱼ₋₁₎. In these implementations, the N sub-frames of the second pixel circuit 12 in one frame are ordered in ascending order of light-emitting phase duration, and the ratio of the light-emitting phase durations of two adjacent sub-frames in the sorting gradually increases. That is, the light-emitting phase durations corresponding to the N sub-frames ordered in ascending order of light-emitting phase duration gradually increase, and the increasing amplitude gradually becomes larger. Thus, it can match the sub-frame instantaneous luminance allocation rule and the light-emitting characteristics of the LED, enabling the second light-emitting device PD2 to emit light more often with high efficiency, and also being able to avoid the emission wavelength shift and improve the display effect.

In some implementations, N≥3, j is an integer, and 2<j+1≤N. As illustrated in FIG. 9, the first pixel circuit 11 has the light-emitting phase duration t₁₍ⱼ₋₁₎ in the (j−1)th sub-frame Z1(j−1) corresponding to it, the light-emitting phase duration t₁ⱼ in the jth sub-frame Z1j corresponding to it, and the light-emitting phase duration t₁₍ⱼ₋₁₎ in the (j+1)th sub-frame Z1(j+1) corresponding to it; where t₁ⱼ−t₁₍ⱼ₋₁₎≤t₁₍ⱼ₋₁₎−t₁ⱼ. In these implementations, the N sub-frames of the first pixel circuit 11 in one frame are ordered in ascending order of light-emitting phase duration, and the difference between the light-emitting phase durations of two adjacent sub-frames in the sorting (the longer light-emitting phase duration minus the shorter light-emitting phase duration) gradually increases, which is equivalent to that the light-emitting durations corresponding to the N sub-frames ordered in ascending order of light-emitting phase duration gradually increase and the increasing amplitude gradually becomes larger. Alternatively, the N sub-frames of the first pixel circuit 11 in one frame may be ordered in ascending order of light-emitting phase duration, and the difference between the light-emitting phase durations of two adjacent sub-frames in the sorting is a fixed value, that is, the light-emitting durations corresponding to the N sub-frames ordered in ascending order of light-emitting phase duration gradually increase and the increasing amplitude is a fixed value. Thus, it can match the sub-frame instantaneous luminance allocation rule and the light-emitting characteristics of the LED, enabling the first light-emitting device PD1 to emit light more often with high efficiency, and also being able to avoid the emission wavelength shift and improve the display effect.

In some implementations, N≥3, j is an integer, and 2<j+1≤N. As illustrated in FIG. 9, the second pixel circuit 12 has the light-emitting phase duration t₂₍ⱼ₋₁₎ in the (j−1)th sub-frame Z2(j−1) corresponding to it, the light-emitting phase duration t₂ⱼ in the jth sub-frame Z2j corresponding to it, and the light-emitting phase duration t₂₍ⱼ₊₁₎ in the (j+1)th sub-frame Z2(j+1) corresponding to it; where t₂ⱼ−t₂₍ⱼ₋₁₎≤t₂₍ⱼ₋₁₎−t₂ⱼ. In these implementations, the N sub-frames of the second pixel circuit 12 in one frame are ordered in ascending order of light-emitting phase duration, and the difference between the light-emitting phase durations of two adjacent sub-frames in the sorting (the longer light-emitting phase duration minus the shorter light-emitting phase duration) gradually increases, which is equivalent to that the light-emitting durations corresponding to the N sub-frames ordered in ascending order of light-emitting phase duration gradually increase and the increasing amplitude gradually becomes larger. Alternatively, the N sub-frames of the second pixel circuit 12 in one frame may be ordered in ascending order of light-emitting phase duration, and the difference between the light-emitting phase durations of two adjacent sub-frames in the sorting is a fixed value, that is, the light-emitting durations corresponding to the N sub-frames ordered in ascending order of light-emitting phase duration gradually increase and the increasing amplitude is a fixed value. Thus, it can match the sub-frame instantaneous luminance allocation rule and the light-emitting characteristics of the LED, enabling the second light-emitting device PD2 to emit light more often with high efficiency, and also being able to avoid the emission wavelength shift and improve the display effect.

In some implementations, FIG. 10 is another schematic diagram of light-emitting phases of pixel circuits in sub-frames provided by an embodiment of the present application. FIG. 10 schematically illustrates a 1st sub-frame Z−1, a 2nd sub-frame Z−2, . . . , and an Nth sub-frame Z−N displayed in chronological order in one frame, taking N≥3 as an example. As can be seen from FIG. 10, the 1st sub-frame Z−1 displayed in chronological order is a 1st sub-frame Z11 corresponding to the first pixel circuit 11 and ordered in ascending order of light-emitting phase duration, and also a 1st sub-frame Z21 corresponding to the second pixel circuit 12 and ordered in ascending order of light-emitting phase duration; the 2nd sub-frame Z−2 displayed in chronological order is a 2nd sub-frame Z12 corresponding to the first pixel circuit 11 and ordered in ascending order of light-emitting phase duration, and also a 2nd sub-frame Z22 corresponding to the second pixel circuit 12 and ordered in ascending order of light-emitting phase duration; and the Nth sub-frame Z−N displayed in chronological order is an Nth sub-frame ZIN corresponding to the first pixel circuit 11 and ordered in ascending order of light-emitting phase duration, and also an Nth sub-frame Z2N corresponding to the second pixel circuit 12 and ordered in ascending order of light-emitting phase duration. That is, in one frame of the display panel, a pth sub-frame Z1p corresponding to the first pixel circuit 11 and a pth sub-frame Z2p corresponding to the second pixel circuit 12 are the same sub-frame displayed in chronological order, where p is an integer and 1≤p≤N. Such a setting enables the sub-frame with a long light-emitting phase duration of the first pixel circuit 11 and the sub-frame with a long light-emitting phase duration of the second pixel circuit 12 to be displayed within the same sub-frame time, and the sub-frame with a short light-emitting phase duration of the first pixel circuit 11 and the sub-frame with a short light-emitting phase duration of the second pixel circuit 12 to be displayed within the same sub-frame time. In each sub-frame ordered by display time, the light-emitting durations of the first light-emitting device PD1 and the second light-emitting device PD2 will not differ too much, which can improve visual color shift and enhance the display effect.

In further implementations, FIG. 11 is another schematic diagram of light-emitting phases of pixel circuits in sub-frames provided by an embodiment of the present application. FIG. 11 schematically illustrates a 1st sub-frame Z−1, a 2nd sub-frame Z−2, . . . and an Nth sub-frame Z−N displayed in chronological order in one frame, taking N≥3 as an example. As can be seen from FIG. 11, the 1st sub-frame Z−1 displayed in chronological order is a 2nd sub-frame Z12 corresponding to the first pixel circuit 11 and ordered in ascending order of light-emitting phase duration, and also a 1st sub-frame Z21 corresponding to the second pixel circuit 12 and ordered in ascending order of light-emitting phase duration; and the 2nd sub-frame Z−2 displayed in chronological order is a 1st sub-frame Z11 corresponding to the first pixel circuit 11 and ordered in ascending order of light-emitting phase duration, and also a 2nd sub-frame Z22 corresponding to the second pixel circuit 12 and ordered in ascending order of light-emitting phase duration. Among the N sub-frames displayed in chronological order, at least two sub-frames correspond to sub-frames at different sequential positions in the sorting by light-emitting phase duration of the first pixel circuit 11 and the second pixel circuit 12, respectively.

In some implementations, in one frame of the display panel: the light-emitting phase durations of the first pixel circuit 11 in the N sub-frames displayed in chronological order gradually increase or gradually decrease, and/or the light-emitting phase durations of the second pixel circuit 12 in the N sub-frames displayed in chronological order gradually increase or gradually decrease. For example, in one frame, the light-emitting phase durations of the first pixel circuit 11 in the N sub-frames displayed in chronological order gradually increase, and the light-emitting phase durations of the second pixel circuit 12 in the N sub-frames displayed in chronological order gradually increase. Alternatively, in one frame, the light-emitting phase durations of the first pixel circuit 11 in the N sub-frames displayed in chronological order gradually decrease, and the light-emitting phase durations of the second pixel circuit 12 in the N sub-frames displayed in chronological order gradually decrease. Alternatively, in one frame, the light-emitting phase durations of the first pixel circuit 11 in the N sub-frames displayed in chronological order gradually increase, while the light-emitting phase durations of the second pixel circuit 12 in the N sub-frames displayed in chronological order gradually decrease. In these implementations, in the N sub-frames included in one frame and displayed in chronological order, the light-emitting phase durations corresponding to the first pixel circuit 11 change gradually, and/or the light-emitting phase durations corresponding to the second pixel circuit 12 change gradually. The difference in light-emitting durations between adjacent frames of the first light-emitting device PD1 and/or the second light-emitting device PD2 is relatively smaller, which can improve the display effect. Moreover, the signal supply mode of the light-emitting control signals for the first pixel circuit 11 and/or the second pixel circuit 12 is more regular, and the control mode of the display panel is relatively simple.

In some implementations, in at least one of the N sub-frames included in one frame, the time period of the light-emitting phase of the first pixel circuit 11 covers the light-emitting phase of the second pixel circuit 12. Taking the 1st sub-frame Z−1, the 2nd sub-frame Z−2, . . . , and the Nth sub-frame Z−N displayed in chronological order in one frame as illustrated in FIG. 10, with N≥3 as an example, it can be seen that in the 1st sub-frame Z−1, the time period of the light-emitting phase of the first pixel circuit 11 covers the light-emitting phase of the second pixel circuit 12. In other words, the light-emitting phase of the second pixel circuit 12 is completed within the time period of the light-emitting phase of the first pixel circuit 11. Such a setting can reasonably utilize the time within the sub-frame and avoid the sub-frame time being too long from affecting the refresh rate of the display panel.

In some implementations, FIG. 12 is another schematic diagram of light-emitting phases of pixel circuits in sub-frames provided by an embodiment of the present application. FIG. 12 schematically illustrates a 1st sub-frame Z−1, a 2nd sub-frame Z−2, . . . and an Nth sub-frame Z−N displayed in chronological order in one frame, taking N≥3 as an example. As can be seen from FIG. 11, in the 1st sub-frame Z−1 displayed in chronological order, the mid-point of the light-emitting phase of the first pixel circuit 11 coincides with the mid-point of the light-emitting phase of the second pixel circuit 12, that is, the centers of their light-emitting phase durations are at the same time; and in the 2nd sub-frame Z−1 displayed in chronological order, the mid-point of the light-emitting phase of the first pixel circuit 11 coincides with the mid-point of the light-emitting phase of the second pixel circuit 12. Because the human eye does not necessarily capture the three colors of red, green, and blue at the same time, the devices for the three colors (red, green, and blue), each emitting light in different time periods, may cause color shift issues. In the embodiment of the present application, it is set that in at least one of the N sub-frames included in one frame, the mid-point of the light-emitting phase of the first pixel circuit 11 coincides with the mid-point of the light-emitting phase of the second pixel circuit 12, which can be conducive to improving visual color shift and enhancing the display effect.

In an embodiment of the present application, the display panel includes a first light-emitting control line Emit1 and a second light-emitting control line Emit2. The first light-emitting control line Emit1 provides a first light-emitting control signal Emit1, and the second light-emitting control line Emit2 provides a first light-emitting control signal Emit2. As shown in FIG. 4B, the pixel circuits each include the driving transistor Tm and the light-emitting control transistors T0, where the driving transistor Tm and the light-emitting control transistors T0 are connected in series. The first pixel circuit 11 is electrically connected to the first light-emitting control line Emit1, and the second pixel circuit 12 is electrically connected to the second light-emitting control line Emit2. Specifically, the control terminals of the light-emitting control transistors T0 in the first pixel circuit 11 are connected to the first light-emitting control line Emit1, and the control terminals of the light-emitting control transistors T0 in the second pixel circuit 12 are connected to the second light-emitting control line Emit2. As shown in FIG. 1, the pixel circuit in the embodiment includes the light-emitting control transistor M2; in the embodiment of FIG. 2, the pixel circuit includes the first light-emitting control transistor M5 and the second light-emitting control transistor M6.

FIG. 13 is a timing diagram of light-emitting control signals provided by an embodiment of the present application. FIG. 13 takes two consecutive sub-frames Z in one frame displayed by the display panel as an example. In FIG. 13, the positions of the light-emitting phases of the first pixel circuit 11 and the second pixel circuit 12 in the sub-frames Z are filled with patterns for illustration. In conjunction with FIGS. 2 and 13, in the sub-frames Z: the first light-emitting control line Emit1 provides an effective level (taking low level as the effective level for example) to control the first pixel circuit 11 to operate in the light-emitting phase, and the light-emitting phase duration of the first pixel circuit 11 is equal to the duration for which the first light-emitting control line Emit provides the effective level; and the second light-emitting control line Emit2 provides an effective level (taking low level as the effective level for example) to control the second pixel circuit 12 to operate in the light-emitting phase, and the light-emitting phase duration of the second pixel circuit 12 is equal to the duration for which the second light-emitting control line Emit2 provides the effective level.

In the embodiment of the present application, a corresponding light-emitting control line is respectively provided for the first pixel circuit 11 and the second pixel circuit 12, whereby the duration of the light-emitting phase of the first pixel circuit 11 and the duration of the second pixel circuit 12 in a sub-frame can be controlled independently of each other. Thus, it can satisfy that the first pixel circuit 11 corresponds to N sub-frames ordered in ascending order of light-emitting duration, and the second pixel circuit 12 corresponds to N sub-frames ordered in ascending order of light-emitting duration.

In some implementations, one pixel circuit row includes the first pixel circuit 11 and the second pixel circuit 12, and one sub-frame is displayed by driving multiple pixel circuit rows in the display panel row by row. In one pixel circuit row, the first pixel circuit 11 is electrically connected to the first light-emitting control line Emit1, and the second pixel circuit 12 is electrically connected to the second light-emitting control line Emit2. During the process in which the pixel circuits in one pixel circuit row complete the writing phase and the light-emitting phase, the signals provided by the first light-emitting control line Emit1 and the second light-emitting control line Emit2 respectively include effective levels. As shown in FIG. 13, in at least one of the N sub-frames included in one frame: the start moment when the first light-emitting control line Emit1 provides the effective level is no later than the start moment when the second light-emitting control line Emit2 provides the effective level, and/or the end moment when the first light-emitting control line Emit1 provides the effective level is no earlier than the end moment when the second light-emitting control line Emit2 provides the effective level. In the embodiment of the present application, when driving the pixel circuits in the same pixel circuit row to perform the light-emitting phases, the time periods during which the first light-emitting control line Emit1 and the second light-emitting control line Emit2 provide the effective levels are made to overlap as much as possible, which enables the time period of the light-emitting phase of the first pixel circuit 11 to cover the light-emitting phase of the second pixel circuit 12. Such a setting can reasonably utilize the time in the sub-frame and avoid the sub-frame time being too long from affecting the refresh rate of the display panel.

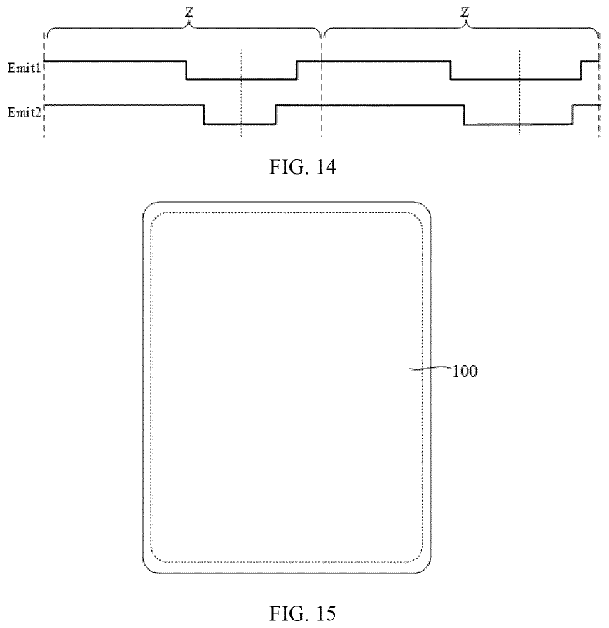

In some implementations, FIG. 14 is another timing diagram of light-emitting control signals provided by an embodiment of the present application. FIG. 14 takes two consecutive sub-frames Z in one frame displayed by the display panel as an example. In at least one of the N sub-frames: when driving the pixel circuits in the same pixel circuit row to perform the light-emitting phases, the mid-point of the effective level provided by the first light-emitting control line Emit1 coincides with the mid-point of the effective level provided by the second light-emitting control line Emit2. Such a setting enables the mid-point of the light-emitting phase of the first pixel circuit 11 to coincide with the mid-point of the light-emitting phase of the second pixel circuit 12 in at least one of the N sub-frames, which can be conducive to improving visual color shift and enhancing the display effect.

Based on the same inventive concept, an embodiment of the present application further provides a display apparatus. FIG. 15 is a schematic diagram of a display apparatus provided by an embodiment of the present application. As shown in FIG. 15, the display apparatus includes the display panel 100 provided by any of the embodiments of the present application. The structure of the display panel 100 has been described in the above embodiments and will not be repeated here. The display apparatus provided by the embodiment of the present application may be an electronic devices with a display function, for example, a mobile phone, a tablet, a computer, a television, and a smart wearable product.

The above are merely preferred embodiments of the present application and are not intended to limit the present application. Any modification, equivalent replacement, improvement, or the like made within the spirit and principle of the present application shall be included in the protection scope of the present application.

Finally, it should be noted that the above embodiments are only used to illustrate the technical solutions of the present application, but not to limit them. Although the present application has been described in detail with reference to the above embodiments, those of skill in the art should understand that they can still modify the technical solutions recited in the above embodiments, or replace some or all of the technical features therein; and these modifications or replacements do not make the essence of the corresponding technical solutions deviate from the scope of the technical solutions of the embodiments of the present application.

What is claimed is:

1. A display panel, comprising a light-emitting device and a pixel circuit, wherein the light-emitting device comprises a first light-emitting device and a second light-emitting device having different emission colors, the pixel circuit comprises a first pixel circuit and a second pixel circuit, the first pixel circuit is connected to the first light-emitting device, and the second pixel circuit is connected to the second light-emitting device; and
one frame of the display panel comprises N sub-frames, where N is an integer and N≥2; operation of the pixel circuit in a sub-frame comprises a light-emitting phase, and the N sub-frames corresponding to the pixel circuit comprise a 1st sub-frame to an Nth sub-frame ordered in ascending order of light-emitting phase duration; the light-emitting device displays gray levels according to a sub-frame instantaneous luminance allocation rule,
wherein the sub-frame instantaneous luminance allocation rule comprises: a gray displayed by the light-emitting device increases as instantaneous luminance of the light-emitting device in the sub-frame increases, the light-emitting device is allocated to emit light in a next sub-frame after reaching a maximum instantaneous luminance in a current sub-frame, and a light-emitting phase duration in the next sub-frame is not less than a light-emitting phase duration in the current sub-frame;
wherein the first pixel circuit has a light-emitting phase duration t₁₁ in the 1st sub-frame corresponding to the first pixel circuit and a light-emitting phase duration t₁₂ in the 2nd sub-frame corresponding to the first pixel circuit; the second pixel circuit has a light-emitting phase duration t₂₁ in the 1st sub-frame corresponding to the second pixel circuit and a light-emitting phase duration t₂₂ in the 2nd sub-frame corresponding to the second pixel circuit; and
where t₁₁/t₁₂>t₂₁/t₂₂.

2. The display panel according to claim 1, wherein t₁₁>t₂₁.

3. The display panel according to claim 1, wherein
the first pixel circuit has a light-emitting phase duration t₁ᵢ in an ith sub-frame corresponding to the first pixel circuit, and
the second pixel circuit has a light-emitting phase duration t₂ᵢ in an ith sub-frame corresponding to the second pixel circuit, where i is an integer and 1<i≤N; and
t₁ᵢ>t₂ᵢ.

4. The display panel according to claim 1, wherein
the first pixel circuit has a light-emitting phase duration t₁ᵢ in an ith sub-frame corresponding to the he first pixel circuit, the second pixel circuit has a light-emitting phase duration t₂ᵢ in an ith sub-frame corresponding to the second pixel circuit, the first pixel circuit has a light-emitting phase duration t₁₍ᵢ₋₁₎ in an (i−1)th sub-frame corresponding to the first pixel circuit, and the second pixel circuit has a light-emitting phase duration t₂₍ᵢ₋₁₎ in an (i−1)th sub-frame corresponding to the second pixel circuit, where i is an integer and 1<i−1≤N−1; and
$${t}_{1 i} - {t}_{1 ( i - 1 (} \geq {t}_{2 i} - {t}_{2 ( i - 1 )} .$$

5. The display panel according to claim 1, wherein
the first pixel circuit has a light-emitting phase duration t₁ⱼ in a jth sub-frame corresponding to the first pixel circuit and a light-emitting phase duration t₁₍ⱼ₊₁₎ in a (j+1)th sub-frame corresponding to the first pixel circuit, and the second pixel circuit has a light-emitting phase duration t₂ⱼ in a jth sub-frame corresponding to the second pixel circuit and a light-emitting phase duration t₂₍ⱼ₊₁₎ in a (j+1)th sub-frame corresponding to the second pixel circuit, where j is an integer and 1<j+1≤N; and
$${t}_{1 j} / {t}_{1 ( j + 1 )} > {t}_{2 j} / {t}_{2 ( j + 1 )} .$$

6. The display panel according to claim 1, wherein
N≥3, j is an integer, and 2<j+1≤N;
the first pixel circuit has a light-emitting phase duration t₁₍ⱼ₋₁₎ in a (j−1)th sub-frame corresponding to the first pixel circuit, a light-emitting phase duration t₁ⱼ in a jth sub-frame corresponding to the first pixel circuit, and a light-emitting phase duration t₁₍ⱼ₊₁₎ in a (j+1)th sub-frame corresponding to the first pixel circuit, where t₁₍ⱼ₋₁₎/t₁ⱼ≤t₁ⱼ/t₁₍ⱼ₊₁₎; and/or
the second pixel circuit has a light-emitting phase duration t₂₍ⱼ₋₁₎ in a (j−1)th sub-frame corresponding to the second pixel circuit, a light-emitting phase duration t₂ⱼ in a jth sub-frame corresponding to the second pixel circuit, and a light-emitting phase duration t₂₍ⱼ₊₁₎ in a (j+1)th sub-frame corresponding to the second pixel circuit, where t₂₍ⱼ₋₁₎/t₂ⱼ≤t₂ⱼ/t₂₍ⱼ₊₁₎.

7. The display panel according to claim 1, wherein
N≥3, j is an integer, and 2<j+1≤N;
the first pixel circuit has a light-emitting phase duration t₁₍ⱼ₋₁₎ in a (j−1)th sub-frame corresponding to the first pixel circuit, a light-emitting phase duration t₁ⱼ in a jth sub-frame corresponding to the first pixel circuit, and a light-emitting phase duration t₁₍ⱼ₊₁₎ in a (j+1)th sub-frame corresponding to the first pixel circuit, where t₁ⱼ−t₁₍ⱼ₋₁₎≤t₁₍ⱼ₊₁₎−t₁ⱼ; and/or
the second pixel circuit has a light-emitting phase duration t₂₍ⱼ₋₁₎ in a (j−1)th sub-frame corresponding to the second pixel circuit, a light-emitting phase duration t₂ⱼ in a jth sub-frame corresponding to the second pixel circuit, and a light-emitting phase duration t₂₍ⱼ₊₁₎ in a (j+1)th sub-frame corresponding to the second pixel circuit, where t₂ⱼ−t₂₍ⱼ₋₁₎≤t_{2 (j+1)}−t₂ⱼ.

8. The display panel according to claim 1, wherein
a sum of light-emitting phase durations of the first pixel circuit in the N sub-frames is t₁, and a sum of light-emitting phase durations of the second pixel circuit in the N sub-frames is t₂, where t1>t2.

9. The display panel according to claim 1, wherein
the first light-emitting device emits light and reaches a maximum instantaneous luminance in the 1st sub-frame corresponding to the first pixel circuit, and a gray displayed by the first light-emitting device is Gm1;
the second light-emitting device emits light and reaches a maximum instantaneous luminance in the 1st sub-frame corresponding to the second pixel circuit, and a gray displayed by the second light-emitting device is Gm2; and
$$Gm 1 > Gm 2.$$

10. The display panel according to claim 9, wherein:
$$N \geq 3 ;$$
the first light-emitting device emits light in n consecutive sub-frames of the first pixel circuit ordered in ascending order of light-emitting phase duration and reaches a maximum instantaneous luminance in the n consecutive sub-frames, and a gray displayed by the first light-emitting device is Gm3, where 2≤n<N;
the second light-emitting device emits light in n consecutive sub-frames of the second pixel circuit ordered in ascending order of light-emitting phase duration and reaches a maximum instantaneous luminance in the n consecutive sub-frames, and a gray displayed by the second light-emitting device is Gm4; and
$$Gm 3 > Gm 4.$$

11. The display panel according to claim 1, wherein
in one frame of the display panel, a pth sub-frame corresponding to the first pixel circuit and a pth sub-frame corresponding to the second pixel circuit are a same sub-frame displayed in chronological order, where p is an integer and 1≤p≤N.

12. The display panel according to claim 1, wherein
in one frame of the display panel:
light-emitting phase durations of the first pixel circuit in the N sub-frames displayed in chronological order gradually increase or gradually decrease; and/or
light-emitting phases durations of the second pixel circuit in the N sub-frames displayed in chronological order gradually increase or gradually decrease.

13. The display panel according to claim 1, wherein
in at least one sub-frame of the N sub-frames in one frame, a time period of the light-emitting phase of the first pixel circuit covers a time period of the light-emitting phase of the second pixel circuit.

14. The display panel according to claim 1, wherein
in at least one sub-frame of the N sub-frames in one frame, a mid-point of the light-emitting phase of the first pixel circuit coincides with a mid-point of the light-emitting phase of the second pixel circuit.

15. The display panel according to claim 1, further comprising:
a first light-emitting control line and a second light-emitting control line, wherein the first pixel circuit is electrically connected to the first light-emitting control line, and the second pixel circuit is electrically connected to the second light-emitting control line;
in the sub-frame:
the first light-emitting control line provides an effective level to control the first pixel circuit to operate in the light-emitting phase, and the light-emitting phase duration of the first pixel circuit is equal to a duration for which the first light-emitting control line provides the effective level; and
the second light-emitting control line provides an effective level to control the second pixel circuit to operate in the light-emitting phase, and the light-emitting phase duration of the second pixel circuit is equal to a duration for which the second light-emitting control line provides the effective level.

16. The display panel according to claim 15, wherein
in at least one sub-frame of the N sub-frames in one frame, a start moment at which the first light-emitting control line provides the effective level is not later than a start moment at which the second light-emitting control line provides the effective level; and/or an end moment at which the first light-emitting control line provides the effective level is not earlier than an end moment at which the second light-emitting control line provides the effective level.

17. The display panel according to claim 16, wherein
in at least one sub-frame of the N sub-frames in one frame, a mid-point at which the first light-emitting control line provides the effective level coincides with a mid-point at which the second light-emitting control line provides the effective level.

18. The display panel according to claim 15, wherein
the pixel circuit comprises a driving transistor and a light-emitting control transistor, the light-emitting control transistor is connected in series with the driving transistor;
a control terminal of the light-emitting control transistor in the first pixel circuit is connected to the first light-emitting control line; and
a control terminal of the light-emitting control transistor in the second pixel circuit is connected to the second light-emitting control line.

19. The display panel according to claim 1, wherein
an emission wavelength of the first light-emitting device is longer than an emission wavelength of the second light-emitting device.

20. A display apparatus, comprising a display panel, wherein the display panel comprises a light-emitting device and a pixel circuit, wherein the light-emitting device comprises a first light-emitting device and a second light-emitting device having different emission colors, the pixel circuit comprises a first pixel circuit and a second pixel circuit, the first pixel circuit is connected to the first light-emitting device, and the second pixel circuit is connected to the second light-emitting device; and
one frame of the display panel comprises N sub-frames, where N is an integer and N≥2; operation of the pixel circuit in a sub-frame comprises a light-emitting phase, and the N sub-frames corresponding to the pixel circuit comprise a 1st sub-frame to an Nth sub-frame ordered in ascending order of light-emitting phase duration; the light-emitting device displays gray levels according to a sub-frame instantaneous luminance allocation rule,
wherein the sub-frame instantaneous luminance allocation rule comprises: a gray displayed by the light-emitting device increases as instantaneous luminance of the light-emitting device in the sub-frame increases, the light-emitting device is allocated to emit light in a next sub-frame after reaching a maximum instantaneous luminance in a current sub-frame, and a light-emitting phase duration in the next sub-frame is not less than a light-emitting phase duration in the current sub-frame;
wherein the first pixel circuit has a light-emitting phase duration t₁₁ in the 1st sub-frame corresponding to the first pixel circuit and a light-emitting phase duration t₁₂ in the 2nd sub-frame corresponding to the first pixel circuit; the second pixel circuit has a light-emitting phase duration t₂₁ in the 1st sub-frame corresponding to the second pixel circuit and a light-emitting phase duration t₂₂ in the 2nd sub-frame corresponding to the second pixel circuit; and
where t₁₁/t₁₂>t₂₁/t₂₂.
